(19) United States
(12) Patent Application Publication
(10) Pub. No.: US 2003/0100625 A1
(43) Pub. Date: May 29, 2003

(54) Heterogeneous Pd catalysts and microwave irradiation in heck arylation

(76) Inventors: S. Muthukumaru Pillai, Vadodara (IN); A. Wali, Vadodara (IN); Sheo Satish, Den Haag (NL)

Correspondence Address: SUMMA & ALLAN, P.A., 11610 NORTH COMMUNITY HOUSE ROAD, SUITE 200, CHARLOTTE, NC, 28277, US

(21) Appl. No.: 09/977,127

(22) Filed: Oct. 12, 2001

(51) Int. Cl. C08F 2/46; C08J 3/28; C08F 4/06; C08F 4/42

(52) U.S. Cl. 522/66; 522/184; 526/93

(57) ABSTRACT

Microwave-assisted Heck arylations are disclosed using various dispersed Pd systems including the novel Pd/MgO and Pd/SiO₂—Al₂O₃ catalyst.

### BACKGROUND OF THE INVENTION

The Pd(0)-catalyzed reaction of an aryl or vinyl halide with an alkene known as the Heck reaction is an important method of C—C bond formation. Pd(Oac)₂ (where ac is the acetate ion) is generally employed as a soluble catalyst in this organometallic reaction. However, a variety of such reactions are favorably amenable to catalysis by dispersed metals. The heterogeneous catalysts in synthetically useful reactions offer significant economic, practical and environmental advantages. We present here a few Heck arylations using various dispersed Pd (palladium) systems including the novel Pd/MgO and Pd/SiO₂—Al₂O₃ catalyst. Additionally, the use of microwave irradiation in such a reaction is being reported, to our knowledge, for the first time.

Chemical symbols will be used herein in accordance with well-understood conventions, such as the periodic table of the elements. Where informal abbreviations are used, their meaning will be either evident from the text and context, or will be specifically set forth.

### SUMMARY OF THE INVENTION

The invention is a method for generating palladium-catalyzed organic reaction products, comprising performing an organic reaction catalyzed with palladium. In particular embodiments the invention comprises performing Heck reactions in which a first organic species, Org¹X, is reacted with a second organic species, H-Olefin, in order to provide a product, Org¹-Olefin, and wherein microwave energy is supplied to the organic reaction in order to heat the organic reaction.

### DETAILED DESCRIPTION

Experimental

The various supported catalysts were prepared by standard impregnation techniques using Pd(acac)₂ as precursor. These catalysts were then reduced with H₂ at 100° C. h general, the products were characterized by the usual spectral methods and found in agreement with the reported values.

A typical procedure is described for the preparation of cinnamonitrile: A mixture of iodobenzene (2.04 g, 0.01 mole) acrylonitrile (0.53 g, 0.01 mol) 5% Pd/C (0.212 g), PPh₃ (0.078 g), Et₃N (1 g) (Ph=phenyl; Et=ethyl) and CH₃CN (10 mL) were taken in a 160 mL Parr autoclave under N₂ (25 psig). The mixture was heated at 140° C. for 14 hours. After cooling, the reaction mixture was filtered, concentrated and column chromatographed over silica gel using petroleum ether (40-60° C.) as eluent to give cinnamonitrile as a mixture of E and Z isomers (0.80 g). The spectral data of the product matched with the reported values. The yield and selectivity values given in Table 1 are derived from GC analysis (1.5% OV-17) using the internal standard method.

TABLE 1
Arylation of acrylonitrile (“ACN”) over various Pd catalysts^{a}

| | | E:Z isomers of | Selectivity | |
|---|---|---|---|---|
| Catalyst | Yield (%)^{b} | 1 | 1 | 2 |
| Pd(acac)₂ | 70.4 | 82:18 | 100 | |
| 5% Pd/C | 62 | 77:23 | 100 | |
| 5% Pd/γ-Al₂O₃ | 72.4 | 77:23 | 95.4 | 4.6 |
| 5% Pd/MgO | 77.8 | 78:22 | 91.3 | 8.7 |
| 5% Pd/CaCO₃ | 59.3 | 78:22 | 96.5 | 3.5 |
| 0.6% Pt/γ-Al₂O₃ | | No reaction | | |
| 0.3% Pd/SiO₂— | 55.2 | 78:22 | 100 | |
| Al₂O₃ | | | | |
| 0.3% Pd/γ-Al₂O₃ | 86.0 | 74:26 | 96.8 | 3.2 |

^{a}Pd:ACN = 1:100 (mol/mol); CH₃CN = solvent; 140° C.; 14 h; PhI:ACN = 1:1; Et₃N:ACN = 1:1; PPh₃/Pd = 3. All the supported catalysts are reduced before use.
^{b}Based on ACN

Microwave experiments were conducted in CEM MDS 2000 instrument (CEM Corporation, P.O. Box 200, Matthews, N.C. 28106-0200) at 80% power. The machine had a magnetron frequency of 455 MHz and a maximum output of 650 W.

Results and Discussion

Several Pd catalysts have been examined in the reaction of acrylonitrile (ACN) with iodobenzene (Table 1). E and Z isomers of cinnamonitrile (3-phenylacrylonitrile, CgH₇N) are smoothly obtained in a single step. 1-Cyano-2,2-diphenylethene is also formed in varying proportion depending upon reaction conditions. The activity of the catalysts follows the series:

Pd/CaCO₃<Pd/C<Pd(acac)₂<Pd/γ-Al₂O₃<Pd/MgO

Among the 5% loaded catalysts the yield of product is maximum on Pd/MgO. Dossi et al. have reported that in chloride-free Pd/MgO catalysts electron transfer from the strongly basic O²⁻ surface ion to metal surface leads to “anchoring” of the metal to support, J. Chem. Soc., Chem. Commun., 1245 (1994). This prompts higher activity of Pd/MgO catalyst.

However, lower loading of Pd results in higher activity as seen in case of 0.3% Pd/γ-Al₂O₃. Interestingly, the ratio of E and Z isomers of cinnamonitrile formed over supported Pd catalysts is distinct from the homogeneous counterpart. Further, 1-cyano-2, 2-diphenylethene) is formed as byproduct over Pd dispersed on amphoteric Al₂O₃ and basic MgO and CaCO₃ supports.

To establish some generality of dispersed Pd catalysts in Heck arylation, iodobenzene, o-iodoanisole and benzoyl chloride were used as arylating agents for several olefins using 5% Pd/C. As expected, the arylation takes place smoothly with these substrates (Table 2). However, o-iodonitrobenzene was inert under these conditions.

The reduced Pd/MgO was recycled in several runs for arylation of acrylonitrile to examine the stability and life of the catalyst (Table 3). ESCA (electron spectroscopy for chemical analysis) investigations of fresh and recycled Pd/MgO catalysts show that Pd is anchored on MgO. The atomic absorption spectral analysis of the liquid product after a run shows that only a small amount (0.13%) of loaded Pd is leached out, thereby ruling out the involvement of Pd species in the liquid phase as catalyst. The formation of products in the recycle runs by the same Pd/MgO suggests that the reaction is indeed promoted by Pd metal dispersed on the support.

TABLE 2
Heck arylations using 5% Pd/C^{a}

| Iodoarene | Olefin | Products | Yield (%) |
|---|---|---|---|
| o-Iodoanisole | Styrene | 2-Methoxy stilbene | 71 |
| Indobenzene | Styrene | Stilbene (E) | 55 |
| o-Iodoanisole^{b} | Ethylene | 2-Methoxystyrene | 20 |
| | | 2,2′-Dimethoxy stilbene | 7 |
| Iodobenzene | Ethylene | Styrene | 30 |
| | | Stilbene | 17 |
| Iodobenzene | α-Methyl styrene | α-Methyl stilbene | 55 |
| o-Iodoanisole | α-Methyl styrene | α-Methyl-2-methoxy stilbene | 45 |
| Iodobenzene | 1-Decene | Phenyldecene^{c} | 71 |
| Iodobenzene | Acrylonitrile | Cinnomonitrile (Z & E) | 62 |
| Benzoyl chloride | Acrylonitrile | Cinnomonitrile (Z & E)^{d} | 44 |
| Iodobenzene | α-Methylacrylonitrile | α-Methylcinnamonitrile (Z & E) | 31 |

^{a}CH₃CN = solvent; 140° C.; 14 h, isolated yield.
^{b}140° C.; 8 h
^{c}Isomeric mixture
^{d}Benzene solvent, 100° C.

TABLE 3
Activity of Pd/MgO and the effect of recycles on the arylation
of acrylonitrile with iodobenzene^{a}

| | Time | Pd:ACN | | E:Z | Selectivity | |
|---|---|---|---|---|---|---|
| Run | (h) | (mol/mol) | Efficiency^{b} | 1 | 1 | 2 |
| Fresh catalyst | 10 | 1:100 | 71.2 | 78:22 | 97.7 | 2.3 |
| 1^{st} recycle | 10 | 1:200 | 133.6 | 77:23 | 97.5 | 2.5 |
| 2^{nd} recycle | 10 | 1:200 | 27.0 | 78:22 | 100 | — |

^{a}conditions as in Table 1
^{b}efficiency = mole of (1 + 2)/g atom of Pd

Apparently, there is an increase in activity of the catalyst during the first recycle run. An increase in Pd(3d_{5/2})/Mg(2s) intensity ratio of photoelectron lines is observed with the first recycle catalyst compared to reduced catalyst. Further HI formed in the reaction is neutralized by MgO. This additional role of MgO is a key factor in higher activity of first recycle catalyst. Then there is a decrease in activity of the catalyst in the second recycle. This is due to gradual masking of Pd sites with hydrocarbons and generation of non-reducible Pd²+sites.

TABLE 4
Microwave induced Heck reaction of iodobenzene and 1-decene

| | | Conversion to |
|---|---|---|
| Catalyst | Time (min)^{a} | phenyldecene^{b} |
| 5% Pd/C | 10.5 | 53.7 |
| 5% Pd/MgO | 10.0 | 39.2 |
| 5% Pd/γ-Al₂O₃ | 10.0 | 58.6 |
| 0.3% Pd/SiO₂—Al₂O₃ | 6.0 | 53.5 |

^{a}Caution: explosive pressure can build up
^{b}analyzed by GC

In the present study the influence of microwave irradiation was examined to improve the yield and decrease the reaction time. Accordingly, the Heck reaction was designed for high boiling substrates and experiments were conducted in a microwave digester using supported catalysts (Table 4). The comparable activity of the catalysts in nearly the same conditions is discernible besides attesting to the applicability of microwave in Heck arylation.

The invention has been described in detail, with reference to certain preferred embodiments, in order to enable the reader to practice the invention without undue experimentation. A person having ordinary skill in the art will readily recognize that many of the components and parameters may be varied or modified to a certain extent without departing from the scope and spirit of the invention. Furthermore, titles, headings, or the like are provided to enhance the reader's comprehension of this document and should not be read as limiting the scope of the present invention

What is claimed is:

1. A method for generating palladium-catalyzed organic reaction products, comprising performing an organic reaction catalyzed with palladium except Pd/C, the organic reaction being
i) Heck reactions in which a first organic species, Org¹X, is reacted with a second organic species, H-Olefin, in order to provide a product, Org¹-Olefin,
ii) Stille reactions in which a first organic species, Org¹X, is reacted with a second organic species, R¹₃Sn-Org¹, in order to provide a product, Org¹-Org², or
iii) Suzuki reactions in which a first organic species, Org¹X, is reacted with a second organic species, R²₂B-Org³, in order to provide a product, Org¹-Org³,
wherein:
Org¹ is aryl, heteroaryl, vinyl, acetylenyl, alkyl, allyl, benzyl, acyl, or benzoyl, or mono- or poly-substituted aryl, heteroaryl, vinyl, acetylenyl, alkyl, allyl, or benzoyl;
X is a halide, triflate, mesitylate, nonaflate, carbonylhalide, sulfonylhalide, perfluoroalkylsulfonate, arylphosphate, alkylphosphate, diarylarsine, diarylphosphine, diarylstibine, aryliodonium salt or diazonium salt;
H-Olefin is an olefin having a double bond and an olefinic hydrogen atom, the double bond in the H-Olefin being unsubstituted or mono-, di- or tri-substituted;
R¹ is alkyl, aryl or heteroaryl, or mono- or poly-substituted alkyl, aryl or heteroaryl;
Org² and Org³ are both aryl, heteroaryl, vinyl, acetylenyl, alkyl, allyl or benzyl, or mono- or poly-substituted aryl, heteroaryl, vinyl, acetylenyl, alkyl, allyl or benzoyl; and
R² is hydroxy, alkoxy, aryloxy or heteroaryloxy;
wherein microwave energy is supplied to the organic reaction in order to heat said organic reaction.

2. A method according to claim 1, wherein the organic reaction is the Heck reaction.

3. A method according to claim 2, wherein the organic reaction is performed in solution.

4. A method according to claim 2, wherein the organic reaction is performed on a solid support.

5. A method according to claim 4, wherein the first organic species, Org¹, or the second organic species, H-Olefin, is attached to the solid support.

6. A method according to claim 5, wherein the first organic species, Org¹, or the second organic species, H-Olefin, is attached to the solid support via a linker.

7. A method according to claim 2, wherein the organic reaction is part of a combinatorial chemistry process.

8. A method according to claim 1, wherein the microwave energy is solely or predominantly provided in the form of a standing wave.

9. A method according to claim 1, wherein the organic reaction is used in the creation of a chemical library.

10. A method according to claim 1, wherein the microwave energy is provided for a period of 2-7 minutes.
